(19) United States
(12) Patent Application Publication
(10) Pub. No.: US 2011/0041974 A1
(43) Pub. Date: Feb. 24, 2011

(54) TIRE CHAIN WITH REPLACEABLE WEAR INSERTS

(75) Inventors: Maurice Duperré, Quebec (CA); Denis Simard, Quebec (CA); Pierre Tremblay, Quebec (CA); Dominic Byatt, Quebec (CA); Roger-Pierre Cadieux, Quebec (CA); Simon Bergeron, Quebec (CA)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: SCP 89 Inc., Quebec (CA)

(21) Appl. No.: 12/989,299

(22) PCT Filed: Jan. 23, 2009
(86) PCT No.: PCT/CA09/00084

§ 371 Date: Oct. 22, 2010

Related U.S. Application Data
(60) Provisional application No. 61/049,467, filed on May 1, 2008.

(51) Int. Cl. B60C 27/08

(52) U.S. Cl. 152/240

(57) ABSTRACT

The tire chain is adapted for snugly wrapping around an appropriately dimensioned tire and rotating therewith during use. The tire chain has a chain mesh having a plurality of links, and a plurality of wear inserts interspaced on the mesh and mounted to corresponding selected ones of the links. Each one of the wear inserts has a radially-inner component removably secured to a radially-outer component, independently from the integrity of the mesh, with a spacing therebetween within which the corresponding selected link is received and trapped. The radially-outer components having corresponding outward-facing wear portions submitted to wear during use. The wear inserts can be removed and replaced once worn by separating the radially-inner component from the radially-outer component.

### PRIORITY CLAIM

This application claims priority of U.S. provisional application No. 61/049,467, filed May 1, 2008.

### BACKGROUND

Tire chains were used in a wide variety of applications where chain links thereof were exposed and submitted to wear, such as for traction or tire protection purposes. Because tire chains were typically as resistant as the weakest link they included, premature wear of a single one of the chain links often quickly led to a need to replace the entire tire chain, which in turn caused significant chain repair or replacement costs, often combined with significant downtime costs. For this reason, much effort has been spent in the past to devise wear resistant chain links and to achieve tire chain configurations where the links most exposed to wear were selected to have a higher wear resistance.

Protective tire chains for example, which typically include a chain mesh comprising a regular array of chain links arranged in a generally cylindrical configuration to precisely wrap, cover and protect the exposed outer surfaces of large tires from damage and wear in industries such as mining, construction, forestry and quarrying, have seen a strong increase of usage in recent years. This increase is at least partially due to the high increase in tire replacement costs which resulted from the recent scarcity of rubber, which remains today one of the most sought materials in tire making. The mere costs of such protective tire chains for large tires, combined with the costs associated with machine downtime for replacing tire chains has created a strong incentive to even further increase the durability in tire chains.

At least some of the problems outlined above were also encountered in other types of tire chains, such as traction chains, for instance.

Henceforth, although known tire chains were satisfactory to a certain degree, in can now be understood that there remained room for even further improvement.

### SUMMARY

A solution is to provide a protective tire chain which has replaceable wear inserts which are removably mounted to selected ones of the links of the chain link mesh of the tire chain.

A more particular solution is to provide the replaceable wear inserts in two components which can be removably secured to one another, preferably by a fastening method such as bolting, with a spacing kept therebetween, wherein the selected one of the links can thereafter be trapped within the spacing, thereby maintaining the wear insert in a selected position on the mesh.

Such wear inserts can be assembled to specific ones of the chain links and optionally held in place or orientation on the mesh by some of the chain links, and take at least some of the wear which would otherwise be imposed to the chain links. When some of the wear inserts become worn, one or more worn portions of the wear inserts can be removed and replaced. This can be done once the wear insert has been removed from the mesh without affecting the mesh itself. In some embodiments, the wear insert can be entirely replaced with a new one. The protective tire chain, or more particularly the mesh of chain links, can thus last substantially longer than if the wear was applied to the chain links themselves and the time required for servicing, as well as complexity thereof, can be reduced.

In fact, the chain links which are part of the chain mesh are often left non-heat-treated after assembly, due to the large size of the protective tire chains and the costs associated with effective types of heat treatment. Chain links are typically made of a material having a limited hardness or wear resistance. The wear inserts, however, can be specifically engineered to be wear-resistant, and can thereby be made longer-lasting than bare chain links. This can be made by using high-hardness materials and/or by using a wear insert configuration that allows earth or rocks to become packed therein and then protect the wear insert, for example.

Thus, in accordance with one aspect, there is provided a tire chain for snugly wrapping around an appropriately dimensioned tire and rotating therewith during use, the tire chain comprising a chain mesh having a plurality of links, and a plurality of wear inserts interspaced on the mesh and mounted to corresponding selected ones of the links and removable therefrom independently from the integrity of the mesh, each one of the wear inserts having a radially-inner component removably secured to a radially-outer component with a spacing between the secured radially-inner component and radially-outer component within which the corresponding selected link is received and trapped, the radially-outer components having corresponding outward-facing wear portions submitted to wear during use, wherein the wear inserts can be removed and replaced once worn by separating the radially-inner component from the radially-outer component.

In accordance with another aspect, there is provided a tire chain having a chain mesh having a plurality of links, for snugly wrapping around an correspondingly dimensioned tire and rotating therewith during use, the tire chain being CHARACTERIZED IN THAT it further comprises a plurality of interspaced wear inserts removably mounted to selected ones of the links independently from the mesh, each one of the wear inserts having a radially-inner component secured to a radially-outer component with a spacing between the radially-inner component and the radially-outer component within which the corresponding selected link is received and trapped, the radially-outer component having an outward-facing wear portion which is submitted to wear during use, wherein the wear inserts can be removed for replacement by separating the radially-inner component from the radially-outer component.

In accordance with one aspect, there is provided a protective tire chain comprising a mesh having an array of base chain links interconnected by interconnection chain links, and a plurality of wear inserts, each one of the wear inserts having a base portion mounted to a corresponding one of the base chain links, and a wear portion, the protective tire chain being configured and adapted to be wrapped around a tire of given dimensions for rotating therewith during use, with the wear portion of the wear inserts facing outwardly, whereby the wear inserts are mounted to corresponding base chain links but do not form part of the mesh.

### DESCRIPTION OF THE FIGURES

In the appended figures,

FIG. 1 is a perspective view showing an example of a tire chain wrapped around a tire;

FIG. 2 shows a portion of FIG. 1 enlarged to show detail;

FIG. 3 shows a wear insert mounted to a portion of the chain mesh;

FIG. 4 is an exploded view showing the components of FIG. 3;

FIG. 5 is an exploded view of showing a variant of the embodiment shown in FIG. 3;

FIG. 6 is a perspective view showing a variant of the embodiment shown in FIG. 3;

FIG. 7 is a top plan view showing a variant of the embodiment shown in FIG. 1, unwrapped; and

FIG. 8 is a top plan view showing another variant of the embodiment shown in FIG. 1, unwrapped.

### DETAILED DESCRIPTION

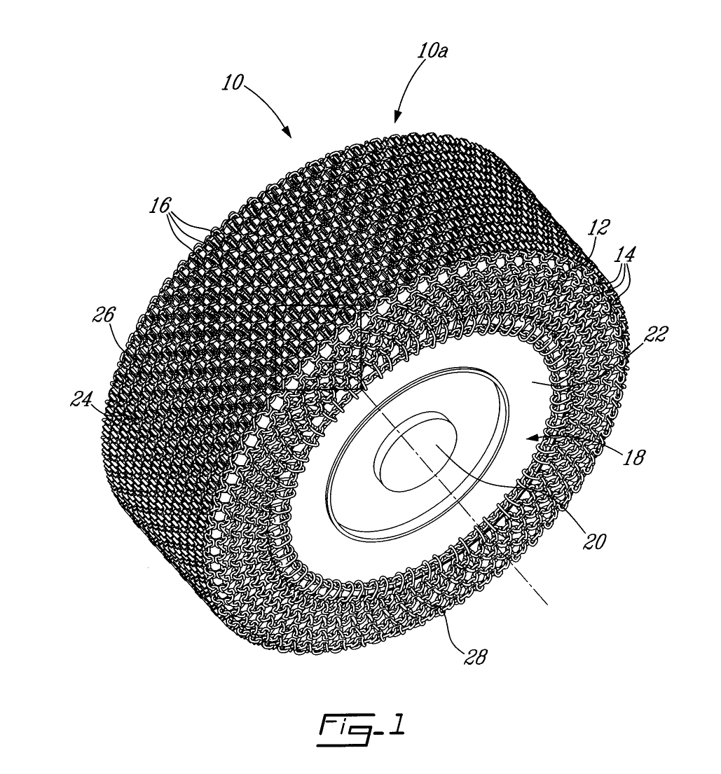

In FIG. 1, an example of an improved tire chain 10 is shown. In this example, the tire chain 10 is a protective tire chain 10a, more precisely of a type commonly used on the large tires 18 of machinery in the quarrying industry.

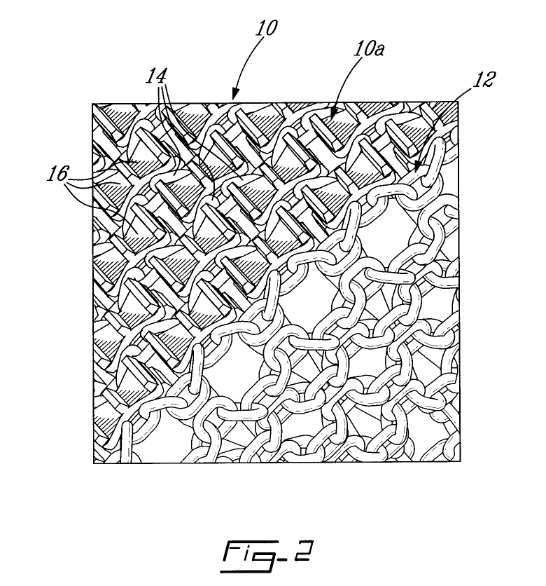

Referring to the enlarged section thereof shown in FIG. 2, the tire chain 10 generally includes a chain mesh 12 having a plurality of interconnected chain links 14, and a plurality of wear inserts 16 removably mounted to the chain mesh 12. It will be noted here that a particularity of this tire chain is that the wear inserts 16 can be removed from the chain mesh 12 for replacement once they are worn, independently of the integrity of the chain mesh 12—i.e. without interconnecting links 14 of the mesh 12 from one another. This will be detailed further below.

Referring back to FIG. 1, the tire 18 generally has a rotation axis 20 and a surface to be covered 22, including a generally cylindrical outer periphery 24 and generally flat lateral sides 26, 28. The tire chain 10 is precisely wrapped around the tire 18 to rotate therewith during use, and thereby protect the tire 18 from wear or other damage. It will be understood that the exemplary tire shape and configuration depicted in FIG. 1 is given for illustrative purposes only, and that in alternate embodiments, the shape, configuration and size of tires can vary and the configuration of the tire chain itself can be modified accordingly. Alternate tire chain uses, such as traction chains for example, are also included as variants, as will be detailed further below with reference to FIGS. 7 and 8.

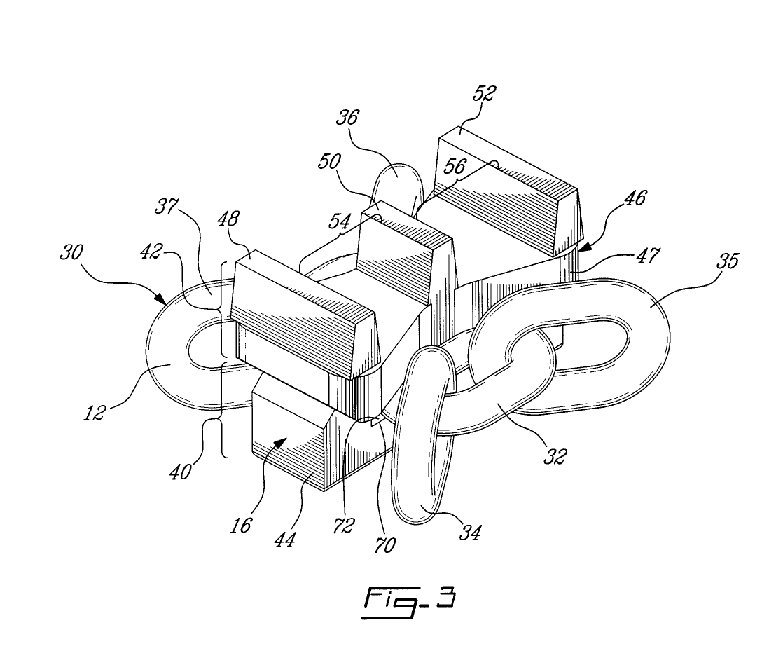

FIG. 3 shows a portion 30 of the protective tire chain 10 in even greater detail. In particular, a portion of the chain mesh 12 is shown including a link which will be referred to herein as a base chain link 32, onto which the wear insert 16 is mounted and trapped, and a plurality of other links 34, 35, 36, 37, referred to herein as interconnection chain links 34, 35, 36, 37, which are used in the mesh 12 to interconnect base chain links 32 with one another in a generally regular array pattern and configuration. The wear insert 16 is mounted to the corresponding base chain link 32.

In this embodiment, the wear insert 16 has a radially-inner component 44—the expression radial relating to the axis 20 of the wheel 18 on which the chain 12 is mounted (see FIG. 1)—which is removably secured to a radially-outer component 46. A recess 70 is provided in the radially-inner component 44 whereas the opposing surface of the radially-outer component 46 is flat, thereby forming a spacing 72 between the radially inner component 44 and the radially-outer component 46 when secured to one another. The spacing 72 is shaped to substantially match the shape and size of the base chain link 32, in a manner that when the radially-inner component 44 is secured to the radially-outer component 46, the base chain link 32 is trapped therebetween, in the spacing 72 provided by recess 70. Due to the presence of the interconnecting chain links 34, 35, 36, 37, the wear insert 16 is thus consequently trapped or kept in position around the base chain link 32 in the mesh 12. Selecting an appropriate size and shape of the wear insert 16 relatively to the configuration of interconnecting chain links 34, 35, 36, 37, can also serve to maintain the relative orientation between the wear insert 38 and the base chain link 32. In alternate embodiments, a recess can be provided in the radially-outer component instead, or partially in both the radially-outer component and the radially-inner component, for example.

For the sake of simplicity, the expressions radially-inner and radially-outer, relative to an axis of the wheel, are used to refer to the two components of the wear insert herein, although it will be understood that wear inserts with the same components can also be used on portions of the tire chain covering lateral sides of the tire.

For future reference, the wear insert 16 can also be said to have a separable base portion 40 by which it is mounted to the base chain link 32, and a wear portion 42 which faces outwardly for exposure to wear when the protective tire chain 10 is wrapped around a tire 18 (see FIG. 1). The radial-outer component 46 includes a body portion 47, a radially-inner surface of which is used at least partially in this embodiment to form the shape and size of the spacing 72, and one or more protrusions 48, 50, 52 which form part of the wear portion 42.

The protrusions 48, 50, 52 are the components of the wear insert 18 which are the most exposed to wear and can therefore be made of a particularly wear-resistant material. For example, the protrusions 48, 50, 52, or any other suitable part of the wear portion, can be made of a material having a greater hardness than a material of the body portion 47, to this end. In one embodiment, manganese steel can be used, or tungsten carbide for example, as the wear-resistant material for the protrusions 48, 50, 52. Manganese steel can harden when submitted to compression. Since the wear of the protrusions 48, 50, 52 typically occurs under compressive stress, manganese steel protrusions can substantially automatically harden, and thereby become more wear-resistant, as wear occurs.

In this specific embodiment, three separate protrusions 48, 50, 52 were used with two spacings 54, 56 therebetween, an arrangement and configuration which can allow earth, rock, or other ground material to become trapped in the spacings 54, 56, or cavities between the protrusions 48, 50, 52, and above the body portion 47. When material becomes trapped in the cavities between the protrusions 48, 50, 52, the trapped material can be subject to at least some of the wear which would otherwise be applied to the wear insert 16, and this can thus reduce the occurrences of wear in the wear insert 16.

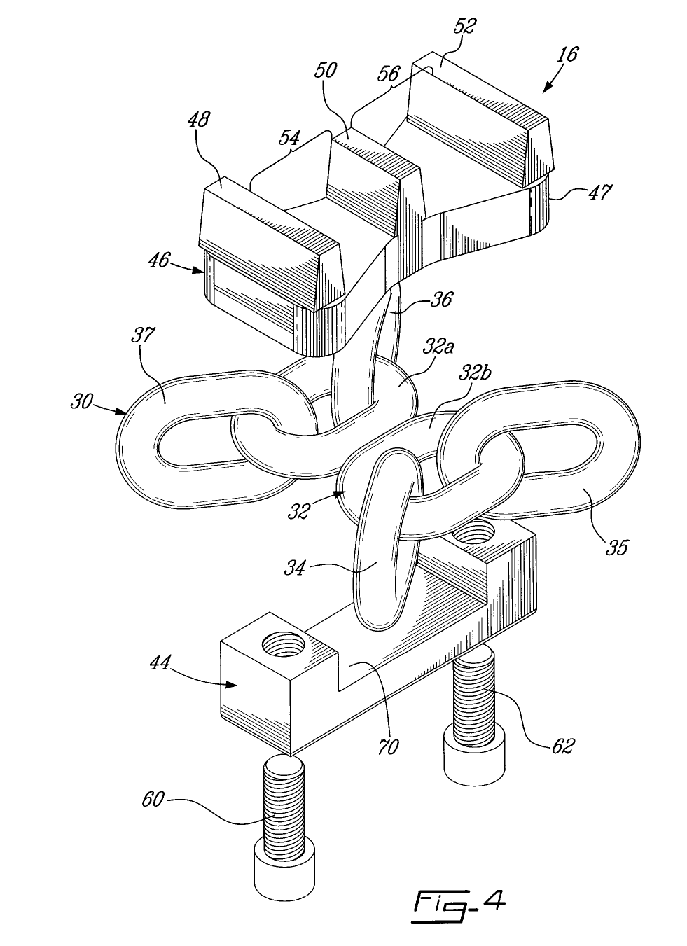

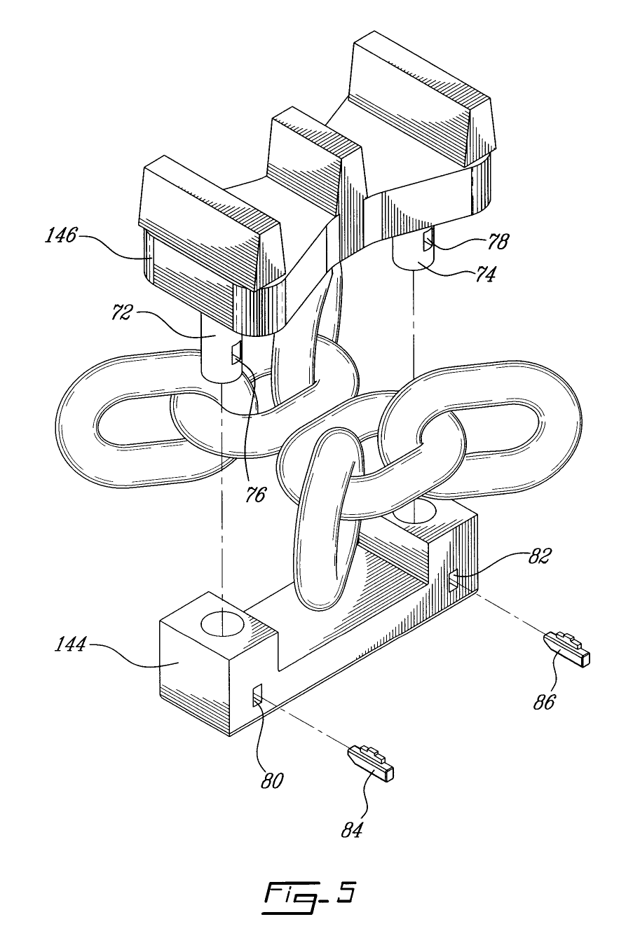

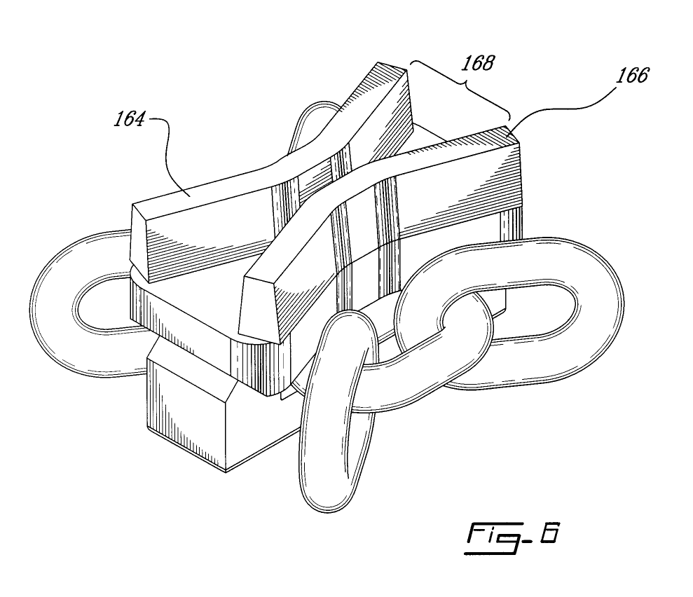

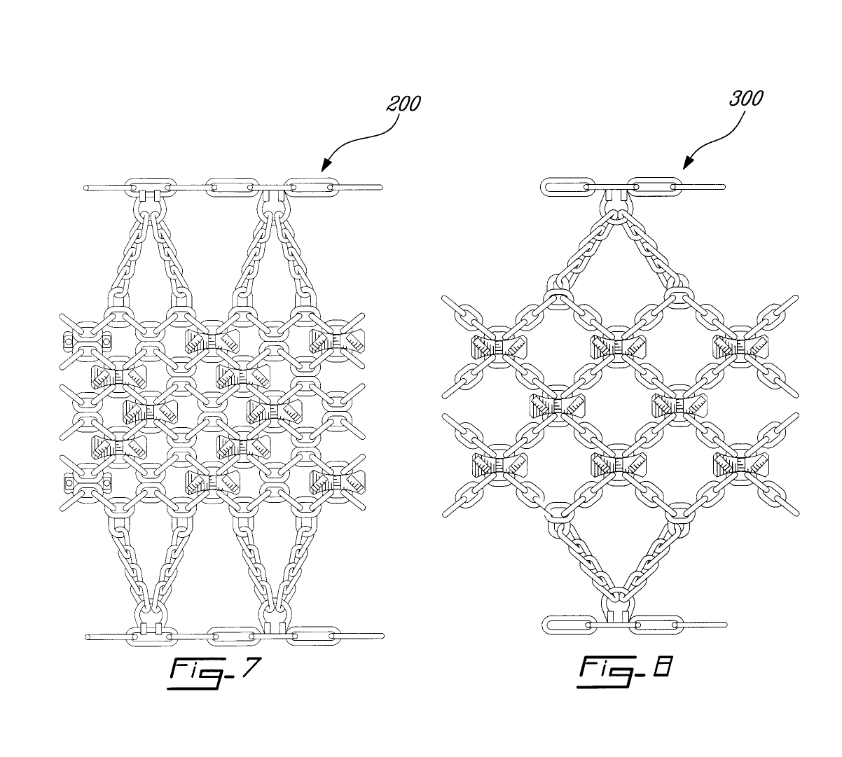

The radially-inner component 44 and the radially-outer component 46 can be removably secured to one another by any suitable means or fasteners. Turning to FIG. 4, for example, which shows the wear insert 16 of FIG. 3 exploded, it will be seen that the radially-inner component 44 can be removably fastened to the radially-outer component 46 by means of fasteners, in this case bolts 60, 62, which traverse the radially-inner component 44 and are secured in mating threaded bores (not shown) defined into the inner surface of the radially-outer component 46. When worn, the radially-outer component 46 can be removed and replaced with a new radially-outer component 46 as a whole, or, the protrusions 48, 50, 52 can be removed (such as unwelded for example) from the radially-outer component 46 and replaced with new ones, for example. In alternate embodiments, the radially-inner component 44 can be removably secured to the radially-outer component 46 by welding and these components be separable from one another by unwelding. It can also be seen in FIG. 4 that the base chain link 32, in this example, is made of two sub-links 32a, 32b, welded to one another.

It is to be understood that the radially-inner component 44 can be removably secured to the radially-outer component 46 by a plurality of alternate suitable removably-securing means.

For example, in the embodiment shown in FIG. 5, the radially-outer component 146 has two inwardly protruding shafts, 72, 74 which are insertable into corresponding bores defined in the radially-inner component 144. The shafts, 72, 74, have corresponding locking apertures 76, 78 therein, and the radially-inner component 144 also has locking apertures 80, 82, each leading into a corresponding bore. When the shafts 72, 74 are inserted into the bores, with the chain link therebetween, the locking apertures 76, 78 therein eventually come into alignment with the locking apertures 80, 82 in the radially-inner component 144. Locking elements can then be inserted therethrough and thereby removably secure the radially-inner component 144 to the radially-outer component. In the embodiment depicted in FIG. 5, the locking elements are lock pins 84, 86, or keys, which can be hammered into the aligned and communicating locking apertures 76, 78, 80, 82 and become jammed therein by plastic deformation of a portion thereof as they are hammered in. To remove the radially-outer component 146 from the radially-inner component 144, the lock pins or keys 84, 86 can be punched back out by inserting a punch into the other end of the channels formed by the communicating locking apertures 76, 78 and 80, 82, on the opposite side of the radially-inner component 144. In an other alternate embodiment, shafts and cotter pins can be used as locking elements instead of lock pins or keys 84, 86, for example.

In the variant shown in FIG. 6, two protrusions 164, 166 arranged in a generally longitudinal side-by-side configuration are used instead of three transversally-oriented protrusions shown in FIGS. 3 and 4. This configuration can also allow material to become compacted in a spacing 168 defined therebetween.

FIGS. 7 and 8 show two additional variants of tire chains 200, 300. These tire chains 200, 300 are traction chains rather than a tire protection chain, by comparison to the tire protection chain 10a described above and illustrated in FIGS. 1 and 2. Both these variants use a plurality of identical wear inserts having a configuration of protrusions which differs from the protrusion configurations which were described above and which is adapted more specifically for high traction rather than for trapping compacted material. In both variants 200, 300, the wear inserts are positioned in a pattern configuration, or array, on the mesh, the pattern being repeated around the circumference of the tire. In the tire chain 200 shown in FIG. 7, the wear inserts are arranged in a repeat series of generally V-shape pattern configuration on the mesh, leaving one generally V-shape set of base chain links bare between adjacent generally V-shaped sets of wear inserts. In the tire chain 300 shown in FIG. 8, wear inserts cover every base chain link, but are kept in a spaced-apart pattern by use of a mesh which includes more than one interconnection chain link between two adjacent base chain links. Other variants and alternate embodiments can also appear from understanding the teachings of this specification.

It will be understood that the examples described above and illustrated are provided for exemplary purposes only and that many alternate embodiments are possible. For instance, it will be understood that the chain mesh configuration shown can greatly depart from that illustrated herein in alternate embodiments. Therefore, the expression base chain link is generally used therein to designed a portion of the chain mesh onto which the wear insert can be mounted, and the expression interconnecting chain links is use to refer to portions of the chain mesh which interconnects the base chain links to each other. The shape and configuration of the wear inserts can greatly depart from those illustrated herein in alternate embodiments and can be specifically designed in view of particular alternate chain mesh configurations. In alternate embodiments, the wear inserts can be made attachable to the base chain links by other means than having an radially-inner component and radially-outer component securable to one another.

Therefore, the scope is indicated by the appended claims.

1. A tire chain for snugly wrapping around an appropriately dimensioned tire and rotating therewith during use, the tire chain comprising a chain mesh having a plurality of links, and a plurality of wear inserts interspaced on the mesh and mounted to corresponding selected ones of the links and removable therefrom independently from the integrity of the mesh, each one of the wear inserts having a radially-inner component removably secured to a radially-outer component with a spacing between the secured radially-inner component and radially-outer component within which the corresponding selected link is received and trapped, the radially-outer components having corresponding outward-facing wear portions submitted to wear during use, wherein the wear inserts can be removed and replaced once worn by separating the radially-inner component from the radially-outer component.

2. The tire chain of claim 1 wherein each one of the wear inserts further comprises locking elements which securely maintain the radially-inner component removably secured to the radially-outer component and allow separating the radially-inner component from the radially-outer component after removal of the locking elements.

3. The tire chain of claim 2 wherein each wear insert comprises two locking elements, each locking element being on a corresponding opposite side of the spacing.

4. The tire chain of claim 2 wherein the locking elements are fasteners.

5. The tire chain of claim 4 wherein the fasteners are bolts.

6. The tire chain of claim 1 wherein the wear inserts are positioned in a pattern configuration on the mesh, the pattern being repeated around the circumference of the tire.

7. The tire chain of claim 1 wherein the wear portion of each wear insert has at least two outwardly-oriented protrusions.

8. The tire chain of claim 7 wherein the at least two outwardly-oriented protrusions are made from a material having a greater hardness than the hardness of a body portion of the radially-outer component.

9. The tire chain of claim 7 wherein the at least two outwardly-oriented protrusions are soldered to a body portion of the radially-outer component.

10. The tire chain of claim 7 wherein the at least two outwardly-oriented protrusions are shaped and relatively positioned in a configuration adapted to receive material to become packed therebetween during use.

11-20. (canceled)

21. A protective tire chain comprising a mesh having an array of base chain links interconnected by interconnection chain links, and a plurality of wear inserts, each one of the wear inserts having a base portion mounted to a corresponding one of the base chain links, and a wear portion, the protective tire chain being configured and adapted to be wrapped around a tire of given dimensions for rotating therewith during use, with the wear portion of the wear inserts facing outwardly, whereby the wear inserts are mounted to corresponding base chain links but do not form part of the mesh.

22. The protective tire chain of claim 21 wherein the base portion of each one of the wear inserts includes a radially-inner component removably fastened to a radially-outer component.

23. The protective tire chain of claim 21 wherein the radially-inner component is removably fastened to the radially-outer component using bolts.

24. The protective tire chain of claim 21 wherein the wear portion of the wear inserts has at least two outwardly-oriented protrusions.

25. The protective tire chain of claim 24 wherein the at least two outwardly-oriented protrusions are configured and adapted to receive material to become packed therebetween during use.

26. The protective tire chain of claim of claim 24 wherein the at least two outwardly-oriented protrusions are removable from the corresponding wear insert.

27. The protective tire chain of claim 21 wherein, once worn, the wear inserts can be removed from the mesh.
